(19) United States
(12) Patent Application Publication
(10) Pub. No.: US 2004/0240052 A1
(43) Pub. Date: Dec. 2, 2004

(54) Multiple-focal imaging device, and a mobile device having the multiple-focal-length imaging device

(75) Inventors: Nobutaka Minefuji, Saitama (JP); Masahiro Oono, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/856,877

(22) Filed: Jun. 1, 2004

(30) Foreign Application Priority Data
Jun. 2, 2003 (JP) 2003-156912

(51) Int. Cl. G02B 1/00; G02B 15/14

(52) U.S. Cl. 359/435

(57) ABSTRACT

A multiple-focal-length imaging device includes at least one image sensor positioned in one plane; and a plurality of image-forming optical systems through which a plurality of images at different magnifications are formed on a plurality of different image-forming areas on the image sensor.

### BACKGROUND OF THE INVENTION

1. Field of the Invention

The present invention relates to a multiple-focal-length imaging device, especially a slim type thereof, and further relates to a mobile device having such an imaging device.

2. Description of the Related Art

Digital cameras have continued to be miniaturized and increased in resolution. In recent years, product differentiation between digital cameras and mobile phones (cellular phones) having a digital camera has become a problem. The current border therebetween has been said the performance capability of approximately one million pixel resolution. Due to the recent demand for further reduction in the thickness of mobile phones, all conventional mobile phones with a digital camera have a fixed-focal-length photographing optical system.

### SUMMARY OF THE INVENTION

The present invention provides a slim multiple-focal-length imaging device which can be incorporated in a mobile device such as a mobile phone.

According to an aspect of the present invention, a multiple-focal-length imaging device is provided, including at least one image sensor positioned in one plane, and a plurality of image-forming optical systems through which a plurality of images at different magnifications are formed on a plurality of different image-forming areas on the image sensor.

It is desirable for the image sensor to have only one image sensor, the plurality of different image-forming areas being formed on the one image sensor.

It is desirable for the plurality of different image-forming areas to be separate from one another on the image sensor.

At least two of the plurality of different image-forming areas can overlap each other on the image sensor.

It is desirable for a light-path intercepting device to be included for selecting one image-forming area from the plurality of different image-forming areas by intercepting the light paths of the plurality of image-forming optical systems which respectively correspond to remaining image-forming areas of the plurality of different image-forming areas which are not selected.

It is desirable for an optical element of one of the plurality of image-forming optical systems to be integrally formed with another optical element of at least one remaining image-forming optical system of the plurality of image-forming optical systems.

The plurality of image-forming optical systems can include a flat-outer-surface common optical element positioned at an object side end of the plurality of image-forming optical systems. The flat-outer-surface common optical element includes a flat surface which is formed on a first surface of the flat-outer-surface common optical element on an object side to serve as a common flat surface of the plurality of image-forming optical systems; and a plurality of lens surfaces formed on a second surface of the flat-outer-surface common optical element on an image side to serve as a plurality of independent lens surfaces of the plurality of image-forming optical systems, respectively.

It is possible for the plurality of image-forming optical systems to share a portion of the flat surface of the flat-outer-surface common optical element. This structure makes it possible to reduce the two-dimensional size of the plurality of image-forming optical systems.

It is desirable for the plurality of image-forming optical systems to include at least one intermediate optical element block, which is positioned between the flat-outer-surface common optical element and the image sensor, and which includes a plurality of lens element portions serving as a plurality of independent optical elements of the plurality of image-forming optical systems, respectively. This construction simplifies the structure of the multiple-focal-length imaging device, and improves the workability of assembling the multiple-focal-length imaging device.

It is desirable for the plurality of image-forming optical systems to include a first lens module which integrally includes each optical element which is provided on the object side in each image-forming optical system; a second lens module which integrally includes each optical element, in each said image-forming optical system, which is provided between the first lens module and the image sensor; and a single the image sensor having a plurality of image-forming areas for corresponding the plurality of image-forming optical systems.

It is possible for one of the plurality of image-forming optical systems to include at least one lens element which are positioned at a different position in an optical axis direction from that of another lens element provided in at least one remaining image-forming optical system of the plurality of image-forming optical systems, the one lens element and the another lens elements being identical to one another in optical surface shape and lens thickness and being made of a same optical material, in order to reduce the production cost.

It is practical for at least one of the plurality of image-forming optical systems to be different in focal length from another of the plurality of image-forming optical systems.

It is possible for three of the plurality of image-forming optical systems be designed as, e.g., a telephoto optical system, a normal optical system and a wide-angle optical system, respectively. In practice, it is desirable for one of the plurality of image-forming optical systems, a focal length of which is longest among the plurality of image-forming optical systems, to have a focal length at least 1.5 times greater than another of the plurality of image-forming optical systems, a focal length of which is shortest among the plurality of image-forming optical systems.

It is possible for one of the plurality of image-forming optical systems be designed as a macro optical system. Specifically, it is desirable for at least one of the plurality of image-forming optical systems to be constructed so that only an object which is positioned at a distance of one of equal to and smaller than 200 times the focal length thereof is brought into focus therethrough.

It is desirable for the multiple-focal-length imaging device to include an infrared absorption filter and/or an optical low-pass filter, positioned in front of all the plurality of different image-forming areas, in accordance with optical characteristics of the image sensor.

The multiple-focal-length imaging device can include a light-path separating device which separates the light paths of the plurality of image-forming optical systems from each other.

The multiple-focal-length imaging device can be incorporated in a mobile device.

The mobile device can be a mobile phone.

The mobile phone can include a display device, the plurality of image-forming optical systems being positioned in front of the display device.

It is desirable for the light-path intercepting device to include a light shield plate having an aperture which is movable in a direction orthogonal to an optical axis direction of the plurality of image-forming optical systems.

In another embodiment, a mobile device is provided, including a plurality of image-forming optical systems, and a single image sensor positioned behind the plurality of image-forming optical systems so that a plurality of images at different magnifications are formed on a plurality of different image-forming areas on the single image sensor through the plurality of image-forming optical systems.

The present disclosure relates to subject matter contained in Japanese Patent Application No.2003-156912 (filed on Jun. 2, 2003) which is expressly incorporated herein by reference in its entirety.

### BRIEF DESCRIPTION OF THE DRAWINGS

The present invention will be described below in detail with reference to the accompanying drawings in which:

FIG. 1 is an elevational view of the outside of one of two parts of a folding mobile phone in which an embodiment of a multiple-focal-length imaging device according to the present invention is incorporated;

FIG. 2 is an elevational view of the inside of the one part of the folding mobile phone shown in FIG. 1, showing an outward appearance of an LCD panel provided in the one part of the folding mobile phone;

FIG. 3 is a front elevational view of the multiple-focal-length imaging device indicated in FIG. 1;

FIG. 4 is a cross sectional view taken along IV-IV line shown in FIG. 3;

FIG. 5 is a cross sectional view taken along V-V line shown in FIG. 3;

FIG. 6 is a cross sectional view taken along VI-VI line shown in FIG. 3;

FIG. 7 is a cross sectional view taken along VII-VII line shown in FIG. 3;

FIG. 8 is a block diagram of the multiple-focal-length imaging device according to the present invention;

FIG. 9 is a perspective view of an embodiment of a flat-outer-surface common optical element and an embodiment of a lens module that serve as optical elements of the multiple-focal-length imaging device according to the present invention;

FIG. 10 is a transverse cross sectional view of the multiple-focal-length imaging device including the optical elements shown in FIG. 9 according to the present invention;

FIG. 11 is a longitudinal cross sectional view of the multiple-focal-length imaging device including the optical elements shown in FIG. 9 according to the present invention;

FIG. 12 is a front elevational view of the multiple-focal-length imaging device according to the present invention which includes two image-forming optical systems and associated two image-forming areas which are independent of each other;

FIG. 13 is a cross sectional view taken along XIII-XIII line shown in FIG. 12;

FIG. 14 is a view similar to that of FIG. 13, showing an embodiment of the multiple-focal-length imaging device which is a modification of the embodiment of the multiple-focal-length imaging device shown in FIGS. 12 and 13;

FIG. 15 is a front elevational view of an embodiment of the multiple-focal-length imaging device, wherein a wide-angle area and a telephoto area on the image-forming area of the image sensor overlap each other to form a overlapping area on the image-forming area of the image sensor;

FIG. 16 is a cross sectional view taken along XVI-XVI line shown in FIG. 15; and

FIG. 17 is a front elevational view of another embodiment of the multiple-focal-length imaging device according to the present invention, showing a case where the image forming area of the image sensor is divided into two image-forming areas, the aspect ratio of each of the two image-forming areas maintaining the original aspect ratio of the image sensor without overlapping each other

### DESCRIPTION OF THE PREFERRED EMBODIMENTS

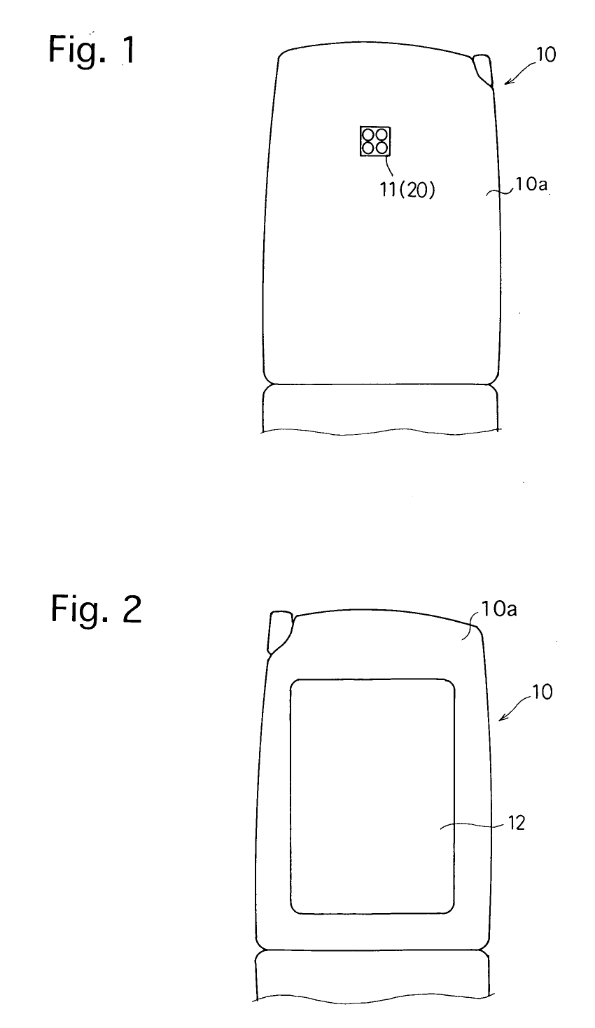

FIGS. 1 and 2 show outward appearances of one of two parts (display-integrated part) of a folding mobile phone 10 in which an embodiment of a multiple-focal-length color imaging device according to the present invention is incorporated. The mobile phone 10 is provided, on an outer surface of a display-integrated part 10a of the mobile phone 10, with an imaging window 11. The mobile phone 10 is provided in the display-integrated part 10a thereof with an LCD panel 12 serving as a display device so that a user can see the LCD panel 12 on an inner surface of the display-integrated part 10a as shown in FIG. 2.

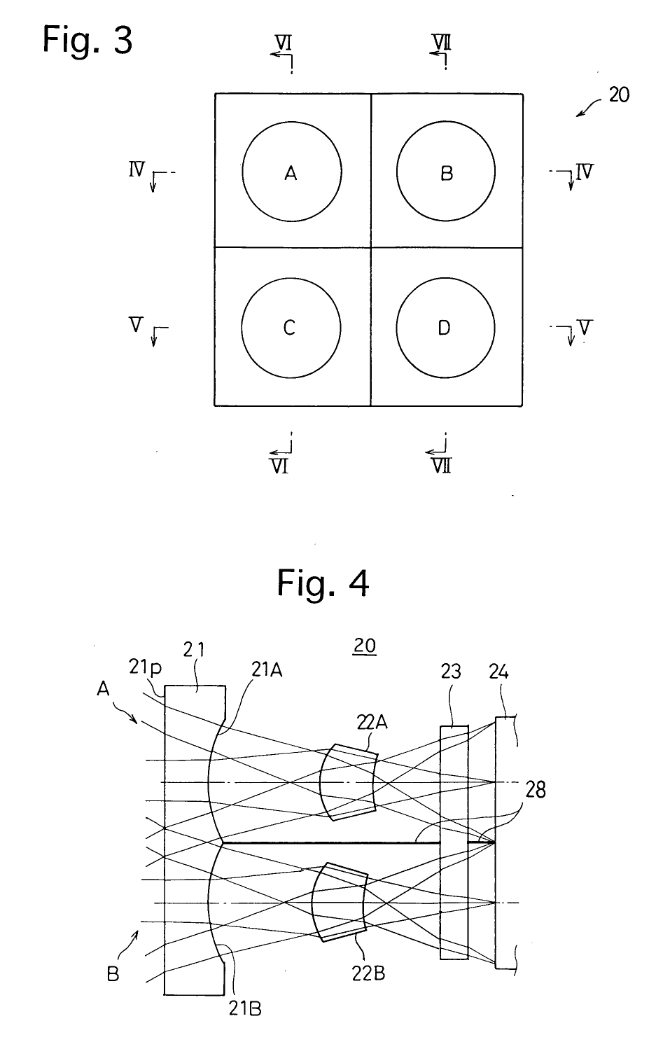

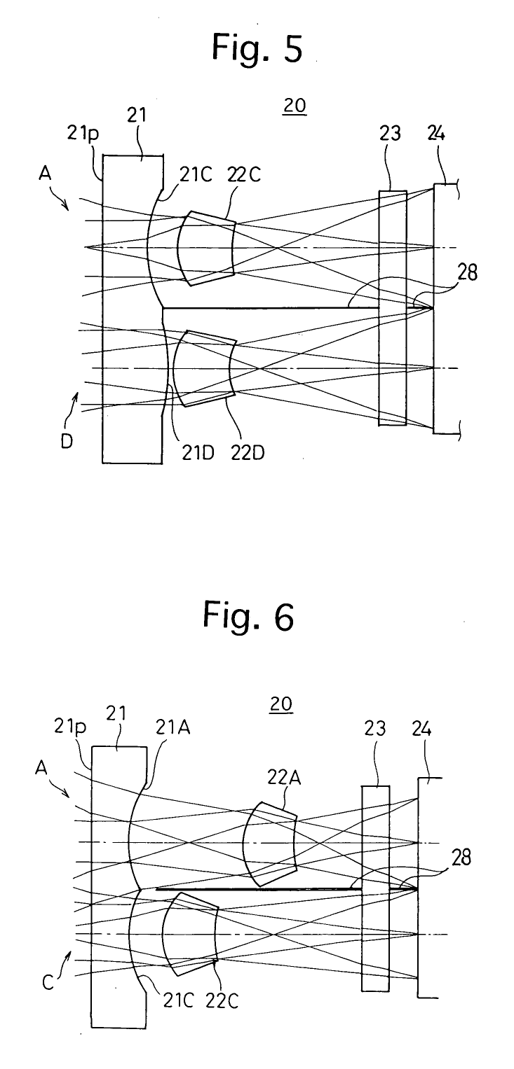

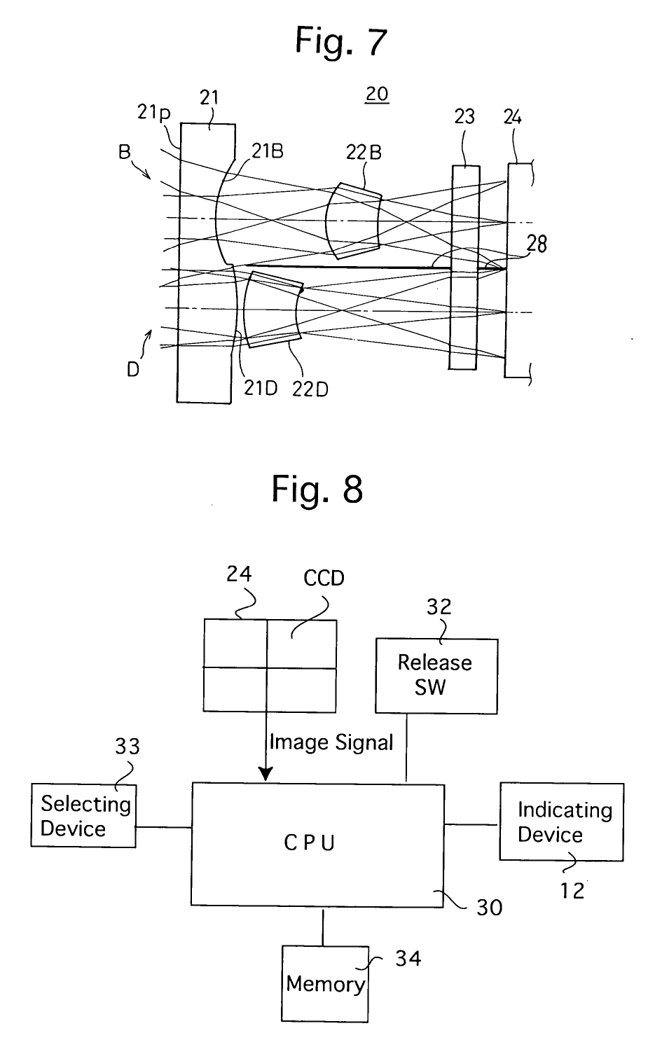

The mobile phone 10 is provided in the imaging window 11 with a multiple-focal-length imaging device 20 having two-dimensionally-arranged four imaging areas (image forming areas). As shown in FIGS. 3 through 7, the multiple-focal-length imaging device 20 is provided with a flat-outer-surface common optical element 21, four different optical elements (first through fourth optical elements) 22A, 22B, 22C and 22D, a common infrared absorption filter 23 and a single color image sensor (color CCD image sensor/image pick-up device) 24 in that order from the object side. The first through fourth optical elements 22A, 22B, 22C and 22D are respectively positioned on four different optical axes which are substantially parallel to one another.

A front surface (first surface/object-side surface) of the flat-outer-surface common optical element 21 is formed as a flat surface 21p, while a rear surface (a surface on the image side) of the flat-outer-surface common optical element 21 is formed to have four independent lens surfaces (first through fourth lens surfaces) 21A, 21B, 21C and 21D. The first through fourth lens surfaces 21A, 21B, 21C and 21D and the first through fourth optical elements 22A, 22B, 22C and 22D constitute four independent image-forming optical systems (first through fourth image-forming optical systems) A, B, C and D having four different focal lengths (four different magnifications), respectively. The infrared absorption filter 23 is in the shape of a plane parallel plate having a size capable of covering the first through fourth image-forming optical systems A, B, C and D. The infrared absorption filter 23 can be substituted for an optical low-pass filter having a size capable of covering the first through fourth image-forming optical systems A, B, C and D. A light path separating wall (light path separating device) 28 is provided in between the first through fourth optical elements 22A, 22B, 22C and 22D to separate each light path thereof from each other.

Four object images at different magnifications are formed on four different areas on the image sensor 24 through the first through fourth image-forming optical systems A, B, C and D, respectively. In the present embodiment of the multiple-focal-length imaging device 20, a rectangular-shaped (substantially square shaped) image forming area of the image sensor 24 is divided into four areas (two by two). For instance, if the size and the number of pixels of the image sensor 24 are one-quarter-inch (diagonal length) and approximately 1.3 million pixels (1280 1024), respectively, the size and the number of pixels of each area of the image sensor 24 can be one-eighth-inch and approximately 0.3 million pixels (640 512), respectively.

The first image-forming optical system A is formed to serve as a wide-angle lens system (short-focus lens system) in which the first lens surface 21A of the flat-outer-surface common optical element 21 and the first optical element 22A are formed as a concave surface and a positive lens element, respectively. The first lens surface 21A and the first optical element 22A are fixedly positioned to be focused on a long-distance object (e.g., focused on an object approximately 1000 times the focal length of the image-forming optical system A).

The second image-forming optical system B is formed to serve as a macro lens system for making a macro photograph state with reference to a wide-angle photograph state made by the first image-forming optical system A. Although the second lens surface 21B of the flat-outer-surface common optical element 21 and the second optical element 22B are identical in structure to the first lens surface 21A of the flat-outer-surface common optical element 21 and the first optical element 22A, respectively, the second optical element 22B (which is formed as a positive lens element) is positioned slightly closer to the object side than the first optical element 22A so that the second image-forming optical system B can be focused on objects very close to the multiple-focal-length color imaging device 20. Specifically, only an object in a distance range of macro photography that is positioned at a distance of not greater than 200 times (200) of the focal length of the second image-forming optical system B is brought into focus through the second image-forming optical system B.

The fourth image-forming optical system D is formed to serve as a telephoto lens system (long-focus lens system) in which the fourth lens surface 21D of the flat-outer-surface common optical element 21 and the fourth optical element 22D are formed as a convex surface and a positive lens element, respectively, to achieve a long focal length of approximately three times of the focal length of the first image-forming optical system A without increasing the length of the optical system.

The third image-forming optical system C is formed to serve as a lens system having an intermediate focal length between the focal length of the first image-forming optical system A and the focal length of the fourth image-forming optical system D. Although the third lens surface 21C of the flat-outer-surface common optical element 21 and the third optical element 22C are identical in structure to the first lens surface 21A of the flat-outer-surface common optical element 21 and the first optical element 22A, respectively, since the third optical element 22C (which is formed as a positive lens element) is positioned closer to the object side than the first optical element 22A (which is formed as a positive lens element), the third image-forming optical system C has a focal length which is approximately double the focal length of the first image-forming optical system A.

As shown in FIG. 8, the image sensor 24 is connected to a CPU (central processing unit) 30 serving as an arithmetic processing unit (APU). Immediately after a release switch 32 is depressed, four image signals which are respectively captured via the four different areas on the image sensor 24 (i.e., four image signals of four images formed at four different focal lengths through the first through fourth image-forming optical systems A through D, respectively) are captured to be input to the CPU 30. A selecting device 33 is connected to the CPU 30. The selecting device 33 selects one of the four image signals beforehand or after an exposure to indicate a corresponding object image on the LCD panel 12. The selected image is stored in a memory 34 which is connected to the CPU 30.

Accordingly, a plurality of object images at different magnifications can be captured at a single time because each of the first through fourth image-forming optical systems A through D forms an image on an associated independent area on the image sensor 24. It is known by those skilled in the art that only an object image formed through one of the first through fourth image-forming optical systems A through D can be captured by selecting the associated light path mechanically or selecting the object image by software through image processing or the like.

A front surface (first surface/object-side surface) of the flat-outer-surface common optical element 21 is formed as the flat surface 21p as described above. As shown in FIGS. 4 through 7, the first through fourth image-forming optical systems A through D share a portion of the flat surface 21p.

It is also common for typical zoom lens cameras which have a variable focal length, via relative movement of each lens group along a singe optical axis, to have a finite number of different focal length steps in the case where zooming is performed by electronic control which has been popularized over recent years. Accordingly, the present embodiment of the image pick-up device (the multiple-focal-length imaging device 20) can be regarded as a zoom lens of a camera which has a stepwise variable focal length, specifically, three focal length steps (four focal length steps if the focal length for macro photography is included). The folding mobile phone 10 becomes closer to the above-mentioned typical zoom lens camera if more image-forming optical systems are provided in the multiple-focal-length imaging device 20. The image signals stored in the memory 34 can be transmitted to another device. This transmitting device can be any conventional device.

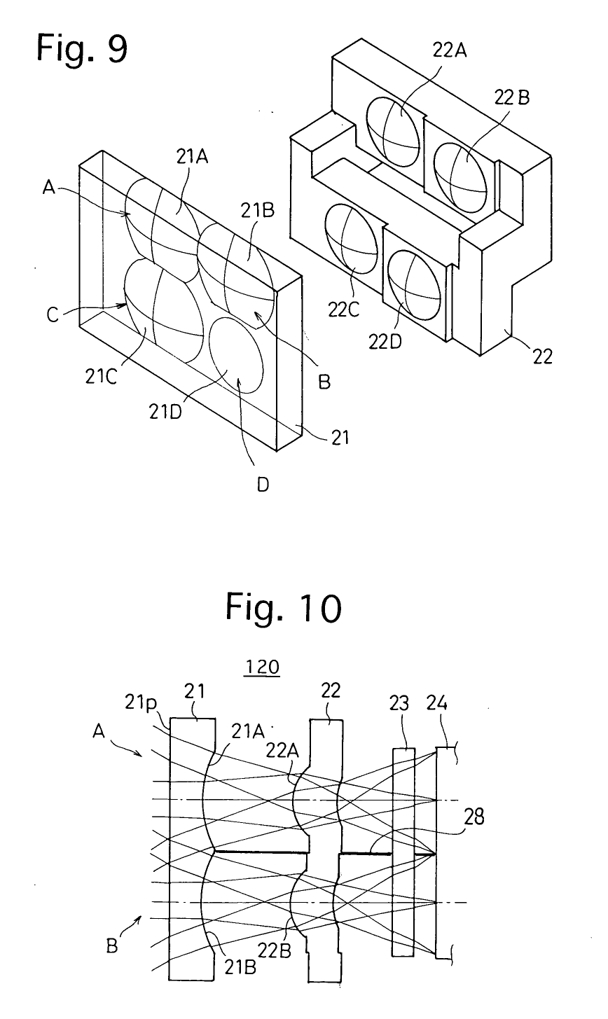

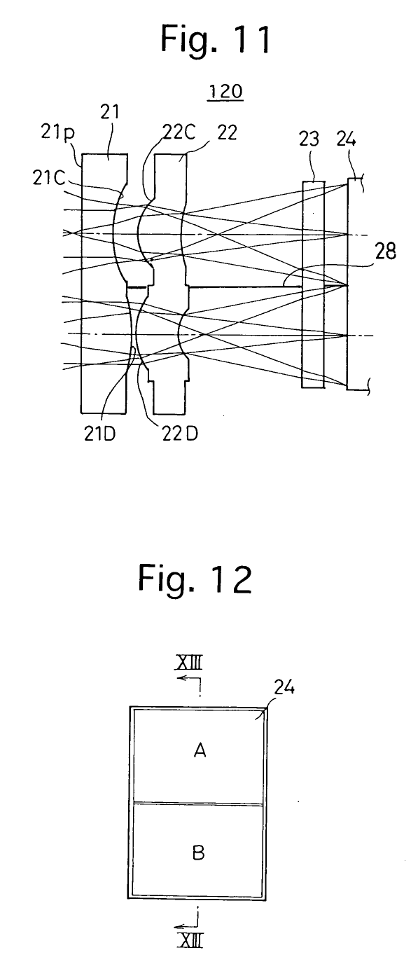

FIGS. 9 through 11 show another embodiment of the multiple-focal-length imaging device (120) wherein a lens module (intermediate optical element block) 22 is molded out of a single synthetic resin mold to include the first through fourth optical elements 22A, 22B, 22C and 22D. In the illustrated embodiment shown in FIGS. 9 through 11, the flat-outer-surface common optical element 21 serves as a first lens module, while the first through fourth optical elements (lens elements) 22A, 22B, 22C and 22D are formed integral with the lens module 22 which serves as a second lens module. Elements of the multiple-focal-length imaging device 120 in FIGS. 9 through 11 which are identical to the multiple-focal-length imaging device 20 shown in FIGS. 3 through 7 are designated by the same reference numerals. If optical elements (lens elements) of the multiple-focal-length imaging device 120 are designed in modules in such a manner, the multiple-focal-length imaging device 120 can be assembled easily and also the positioning of the elements thereof can be easily carried out. Accordingly, a small, slim and simple multiple-focal-length imaging device 120 is obtained.

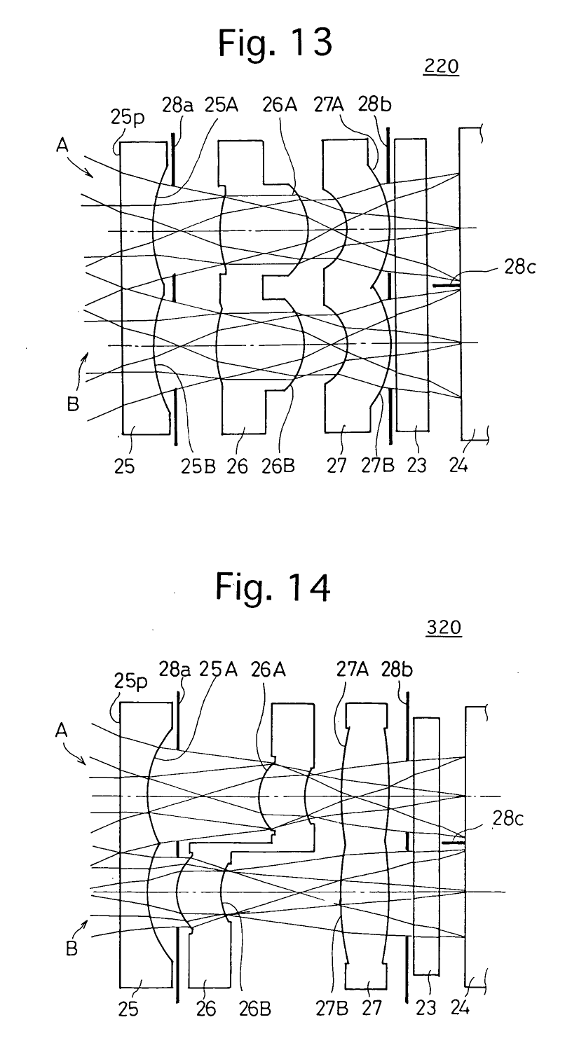

FIGS. 12 and 13 show another embodiment of the multiple-focal-length imaging device (220) in which the image sensor 24 is used with the image forming area thereof being split in two. Namely, this embodiment of the multiple-focal-length imaging device 220 is provided with two independent image-forming optical systems (first and second image-forming optical systems) A and B. In the multiple-focal-length imaging device 220, the aspect ratio (length-to-width) of the image sensor 24 is 4:3. As shown in FIG. 12, the image forming area of the image sensor 24 is divided into equal halves at the center of the image sensor 24 to use all the pixels of the image sensor 24 without wasting any pixels. The infrared absorption filter 23 and the single color image sensor (color CCD) 24 are used for both the first and second image-forming optical systems A and B, and are the same as those of the previous embodiments of the multiple-focal-length imaging devices. The first and second image-forming optical systems A and B have three lens modules: a first lens module (flat-outer-surface common optical element) 25, a second lens module (intermediate optical element block/molded product made of synthetic resin) 26, and a third lens module (intermediate optical element block/molded product made of synthetic resin) 27. A front surface (first surface/object-side surface) of the flat-outer-surface common optical element 25 is formed as a flat surface 25p.

The first lens module 25 is provided on a second surface (rear surface) thereof with two independent lens surfaces (first and second surfaces) 25A and 25B which have the same size and shape. The second lens module 26 is provided with first and second lens element portions (two independent lens element portions) 26A and 26B which have the same size and shape and which are positioned at different positions in the optical axis direction (horizontal direction as viewed in FIG. 13). The third lens module 27 is provided with first and second lens element portions (two independent lens element portions) 27A and 27B which have the same size and shape and which are positioned at the same position in the optical axis direction. The second lens element portion 26B of the second lens module 26 is positioned closer to the object side than the first lens element portion 26A so that the first image-forming optical system A serves as an optical system for long-distance objects and so that the second image-forming optical system B serves as a macro optical system for object close to the folding mobile phone 10. The multiple-focal-length imaging device 220 shown in FIGS. 12 and 13 is provided between the first lens module 25 and the second lens module 26 with a light-path separating wall (light-path separating device) 28a. The multiple-focal-length imaging device 220 is provided immediately in front of the infrared absorption filter 23 with a light-path separating wall (light-path separating device) 28b, and is further provided, immediately in front of the image sensor 24 between the infrared absorption filter 23 and the image sensor 24, with a light-path separating wall (light-path separating device) 28c. Due to the presence of the light-path separating wall 28b and the light-path separating wall 28c, object light passed through the first and second image-forming optical systems A and B are formed as two object images separately on the common image sensor 24, respectively, without the two object images interfering (overlapping) with each other on the image sensor 24.

In the multiple-focal-length imaging device 220, either of the two object images which are respectively formed on two areas on the image sensor 24 through the first and second image-forming optical systems A and B can be selected when using the mobile phone 10. In addition, one of the two object images on the image sensor 24 which is higher in contrast than the other can be determined by software to be automatically stored in the memory 34 by processing an object image at a near distance and an object image at far distance simultaneously through a predetermined image processing operation. Additionally, since the multiple-focal-length imaging device 220 does not have to be provided with any mechanical focusing system to vary focal length, an optical system which makes it possible to photograph objects at different object distances in a wide range with a high contrast can be installed into a vary thin space in the optical axis direction.

FIG. 14 shows a multiple-focal-length imaging device 320 which is a modification of the embodiment of the multiple-focal-length imaging device 220 shown in FIGS. 12 and 13, in which the modifications are made to the shapes of lens surfaces of the first lens module (flat-outer-surface common optical element) 25, the second lens module 26 and the third lens module 27. Likewise with the multiple-focal-length imaging device 220 shown in FIG. 13, the first and second surfaces 25A and 25B on the second surface of the first lens module 25 are the same in size and shape, the first and second lens element portions 26A and 26B of the second lens module 26 are the same in size and shape and are positioned at different positions in the optical axis direction, and the first and second lens element portions 27A and 27B of the third lens module 27 are the same in size and shape and are positioned at the same position in the optical axis direction. The second lens element portion 26B of the second lens module 26 is positioned closer to the object side than the first lens element portion 26A so that the first image-forming optical system A serves as a short-focus lens system (wide-angle optical system) and so that the second image-forming optical system B serves as a long-focus lens system (narrow-angle optical system: an optical system having a high magnification).

In the embodiment of the multiple-focal-length imaging device 320 shown in FIG. 14, both wide-angle photography and narrow-angle photography (high-magnification photography) are possible without moving any optical elements at all, similar to the multiple-focal-length imaging device 220 shown in FIG. 13. Accordingly, the image-forming optical systems of the multiple-focal-length imaging device 320 can be installed into a vary thin space in the optical axis direction in a space-efficient manner, as compared with a conventional multiple-focal-length imaging device in which one or more lens elements are moved to perform a zooming operation or a focal-length switching operation. Moreover, the multiple-focal-length imaging device 320 has excellent impact-resistance, and can be made at a low cost of production.

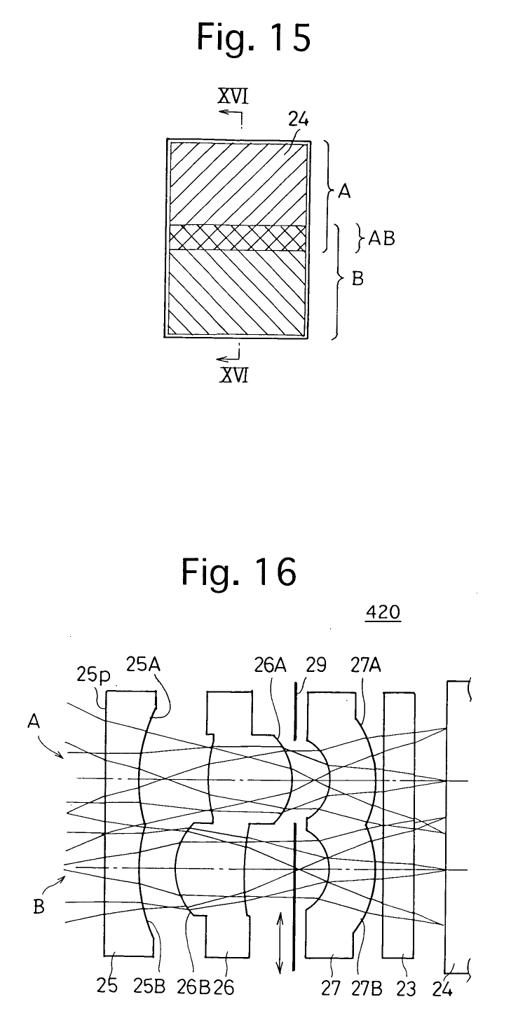

FIGS. 15 and 16 show another embodiment of the multiple-focal-length imaging device (420). In this embodiment a wide-angle area and a telephoto area (upper and lower areas as viewed in FIG. 15) on the image-forming area of the image sensor 24 overlap each other to form a overlapping area AB on the image-forming area of the image sensor 24 to make full use of the pixels of the image sensor 24 with efficiency while maintaining the aspect ratio of the captured object image before and after splitting of the image-forming area of the image sensor 24. In this embodiment of the multiple-focal-length imaging device 420, the first lens module (flat-outer-surface common optical element) 25, the second lens module 26 and the third lens module 27 constitute the first and second image-forming optical systems A and B which serve as a wide-angle lens system and a telephoto lens system, respectively, just as the above described embodiment of the multiple-focal-length imaging device 220 shown in FIGS. 12 and 13. The first and second surfaces 25A and 25B on the second surface of the first lens module 25 are the same in size and shape, while the first and second lens element portions 27A and 27B of the third lens module 27 are the same in size and shape, and are positioned at the same position in the optical axis direction. On the other hand, the two lens portions 26A and 26B of the second lens module 26 are formed to serve as a wide-angle lens system and a telephoto lens system, respectively, which are independent of each other.

Since the overlapping area AB exists on the image-forming area of the image sensor 24, the multiple-focal-length imaging device 420 is provided between the second lens module 26 and the third lens module 27 with a light-path selecting device (light-path intercepting device) 29 which intercepts a light path of one of the two image-forming optical systems A and B, which is not selected, to accurately select one image-forming area from the two image-forming areas (wide-angle area and telephoto area) on the image sensor 24. As shown in FIG. 16, the light-path selecting device 29 is in the form of a light shield plate having an aperture which is movable in a direction orthogonal to the optical axis direction of the plurality of image-forming optical systems, i.e., in the vertical direction as viewed in FIG. 16.

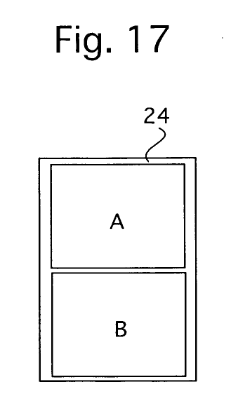

FIG. 17 shows a case where the image-forming area of the image sensor 24 is divided into two image-forming areas, the aspect ratio of each of the two image-forming areas maintaining the original aspect ratio of the image sensor 24 without overlapping each other.

It is desirable that the image sensor 24 be a single-board image sensor. However, a plurality of image sensors can serve as the image sensor 24 so long as the plurality of image sensors are positioned in a common plane.

As can be understood from the foregoing, according to each of the above described multiple-focal-length imaging devices 20 through 420 according to the present invention, an extremely slim multiple-focal-length imaging device which can be incorporated in a mobile device such as a mobile phone is achieved.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A multiple-focal-length imaging device comprising:
at least one image sensor positioned in one plane; and
a plurality of image-forming optical systems through which a plurality of images at different magnifications are formed on a plurality of different image-forming areas on said image sensor.

2. The multiple-focal-length imaging device according to claim 1, wherein said image sensor comprises only one image sensor, said plurality of different image-forming areas being formed on said one image sensor.

3. The multiple-focal-length imaging device according to claim 1, wherein said plurality of different image-forming areas are separate from one another on said image sensor.

4. The multiple-focal-length imaging device according to claim 2, wherein at least two of said plurality of different image-forming areas overlap each other on said image sensor.

5. The multiple-focal-length imaging device according to claim 1, further comprising a light-path intercepting device for selecting one image-forming area from said plurality of different image-forming areas by intercepting the light paths of said plurality of image-forming optical systems which respectively correspond to remaining image-forming areas of said plurality of different image-forming areas which are not selected.

6. The multiple-focal-length imaging device according to claim 1, wherein an optical element of one of said plurality of image-forming optical systems is integrally formed with another optical element of at least one remaining image-forming optical system of said plurality of image-forming optical systems.

7. The multiple-focal-length imaging device according to claim 1, wherein said plurality of image-forming optical systems comprise a flat-outer-surface common optical element positioned at an object side end of said plurality of image-forming optical systems,
wherein said flat-outer-surface common optical element includes:
a flat surface which is formed on a first surface of said flat-outer-surface common optical element on an object side to serve as a common flat surface of said plurality of image-forming optical systems; and
a plurality of lens surfaces formed on a second surface of said flat-outer-surface common optical element on an image side to serve as a plurality of independent lens surfaces of said plurality of image-forming optical systems, respectively.

8. The multiple-focal-length imaging device according to claim 7, wherein said plurality of image-forming optical systems share a portion of said flat surface of said flat-outer-surface common optical element.

9. The multiple-focal-length imaging device according to claim 7, wherein said plurality of image-forming optical systems comprise at least one intermediate optical element block, which is positioned between said flat-outer-surface common optical element and said image sensor, and which includes a plurality of lens element portions serving as a plurality of independent optical elements of said plurality of image-forming optical systems, respectively.

10. The multiple-focal-length imaging device according to claim 1, wherein said plurality of image-forming optical systems comprises:
a first lens module which integrally includes each optical element which is provided on the object side in each said image-forming optical system;
a second lens module which integrally includes each optical element, in each said image-forming optical system, which is provided between said first lens module and said image sensor; and
a single said image sensor having a plurality of image-forming areas for corresponding said plurality of image-forming optical systems.

11. The multiple-focal-length imaging device according to claim 1, wherein one of said plurality of image-forming optical systems comprises at least one lens element which is positioned at a different position in an optical axis direction from that of another lens element provided in at least one remaining image-forming optical system of said plurality of image-forming optical systems, said one lens element and another lens element being identical to one another in optical surface shape and lens thickness and being made of a same optical material.

12. The multiple-focal-length imaging device according to claim 1, wherein at least one of said plurality of image-forming optical systems is different in focal length from another of said plurality of image-forming optical systems.

13. The multiple-focal-length imaging device according to claim 12, wherein one of said plurality of image-forming optical systems, a focal length of which is longest among said plurality of image-forming optical systems, has a focal length at least 1.5 times greater than another of said plurality of image-forming optical systems, a focal length of which is shortest among said plurality of image-forming optical systems.

14. The multiple-focal-length imaging device according to claim 1, wherein at least one of said plurality of image-forming optical systems is constructed so that only an object which is positioned at a distance of one of equal to and smaller than 200 times the focal length thereof is brought into focus therethrough.

15. The multiple-focal-length imaging device according to claim 1, further comprising an infrared absorption filter positioned in front of all said plurality of different image-forming areas.

16. The multiple-focal-length imaging device according to claim 1, further comprising an optical low-pass filter positioned in front of all said plurality of different image-forming areas.

17. The multiple-focal-length imaging device according to claim 1, further comprising a light-path separating device which separates the light paths of said plurality of image-forming optical systems from each other.

18. The multiple-focal-length imaging device according to claim 1, wherein said multiple-focal-length imaging device is incorporated in a mobile device.

19. The multiple-focal-length imaging device according to claim 18, wherein said mobile device comprises a mobile phone.

20. The multiple-focal-length imaging device according to claim 19, wherein said mobile phone comprises a display device, said plurality of image-forming optical systems being positioned in front of said display device.

21. The multiple-focal-length imaging device according to claim 5, wherein said light-path intercepting device comprises a light shield plate having an aperture which is movable in a direction orthogonal to an optical axis direction of said plurality of image-forming optical systems.

22. A mobile device comprising:
a plurality of image-forming optical systems; and
a single image sensor positioned behind said plurality of image-forming optical systems so that a plurality of images at different magnifications are formed on a plurality of different image-forming areas on said single image sensor through said plurality of image-forming optical systems.
